(19) United States
(12) Patent Application Publication
(10) Pub. No.: US 2008/0257323 A1
(43) Pub. Date: Oct. 23, 2008

(54) Internal combustion engine system and vehicle, and ignition control method for internal combustion engine system

(76) Inventor: Hitoki Sugimoto, Toyota-shi (JP)

Correspondence Address: KENYON & KENYON LLP, 1500 K STREET N.W., SUITE 700, WASHINGTON, DC, 20005, US

(21) Appl. No.: 11/976,258

(22) Filed: Oct. 23, 2007

(30) Foreign Application Priority Data
Nov. 7, 2006 (JP) 2006-301982

(51) Int. Cl. F02P 9/00

(52) U.S. Cl. 123/625

(57) ABSTRACT

When a transient knocking occurrence prediction condition is met, that is, when a cooling water temperature θw is not lower than a threshold value θwref, an intake air quantity Qa is not smaller than a threshold value Qaref, and an intake air quantity difference ΔQa is not smaller than a threshold value ΔQaref (S230 to S250), ignition is accomplished for the object cylinder at target ignition timing Tf* delayed from timing T1 (S270, S300, S350). Subsequently, ignition is accomplished for the object cylinder in succession at the target ignition timing Tf* advanced by an advance amount Δα that tends to decrease as the rotation speed Ne of an engine 22 increases (S310, S300, S350). Thereby, when the rotation speed Ne of the engine 22 is relatively high, the target ignition timing Tf* can be restrained from advancing rapidly, that is, the target ignition timing Tf* can be restrained from advancing to timing T1 before delay in too short a period of time. As the result, the occurrence of knocking can be restrained.

### BACKGROUND

1. Technical Field

The present invention relates to an internal combustion engine system and a vehicle, and an ignition control method for the internal combustion engine system.

2. Related Art

Conventionally, as an internal combustion engine system of this type, a system in which when knocking is detected by a knock sensor for detecting knocking of an internal combustion engine, ignition timing is corrected to the delay side has been proposed (for example, refer to Patent Document 1). In this system, when the basic ignition timing based on the operating state of internal combustion engine is on the delay side of the preceding ignition timing, the ignition timing is delayed from the basic ignition timing by a damped delay amount obtained by multiplying a predetermined delay amount by a damping coefficient in the range of 0 to 1 to set the final ignition timing, by which knocking is restrained, and also excessive delay is prevented.

Patent Document 1: Japanese Patent Laid-Open No. 6-17733

### SUMMARY

As described above, in the above-described internal combustion engine system, to restrain the occurrence of knocking is thought to be one of problems. When the ignition timing is delayed and thereafter advanced to the timing before delay, if the ignition timing is advanced rapidly, that is, if the ignition timing is advanced to the timing before delay in too short a period of time, knocking may occur.

The internal combustion engine system and the vehicle, and the ignition control method for the internal combustion engine system in accordance with the present invention have an object of restraining the occurrence of knocking.

The internal combustion engine system and the vehicle, and the ignition control method for the internal combustion engine system in accordance with the present invention took measures as described below to achieve the above object.

The present invention is directed to an internal combustion engine system provided with an internal combustion engine having a plurality of cylinders. The internal combustion engine system includes: an igniting unit capable of accomplishing ignition for each cylinder of the internal combustion engine; an engine rotation speed detecting module for detecting an engine rotation speed, which is a rotation speed of the internal combustion engine; a target ignition timing setting module configured so that when an operating state condition that the operating state of the internal combustion engine is a predetermined operating state is met, timing on a delay side is set as a target ignition timing as compared with a timing at usual time when the operating state condition is not met, and after the setting, timing advanced in succession toward the timing at usual time with a change degree based on the detected engine rotation speed is set as the target ignition timing; and an ignition control module for controlling the igniting unit so that ignition is accomplished at the set target ignition timing.

In the internal combustion engine system in accordance with the present invention, the igniting unit is controlled so that when the operating state condition that the operating state of the internal combustion engine is the predetermined operating state is met, the timing on the delay side is set as the target ignition timing as compared with the timing at the usual time when the operating state condition is not met and ignition is accomplished at the set target ignition timing, and subsequently the igniting unit is controlled so that the timing advanced in succession toward the timing at the usual time with the change degree based on the engine rotation speed, which is the rotation speed of the internal combustion engine, is set as the target ignition timing and ignition is accomplished at the set target ignition timing. Therefore, when the condition is met, after ignition has been accomplished at the timing on the delay side of the timing at the usual time, ignition is accomplished at the timing advanced in succession toward the timing at the usual time with the change degree based on the engine rotation speed. Therefore, if a more appropriate change degree is set based on the engine rotation speed, the target ignition timing can be restrained from advancing rapidly, that is, the target ignition timing can be restrained from advancing to the timing at the usual time in too short a period of time, whereby the occurrence of knocking can be restrained. The term “the predetermined operating state” includes an operating state in which knocking may occur due to a sudden change in the operating state of internal combustion engine.

In one preferable embodiment of the internal combustion engine system of the present invention, the target ignition timing setting module may be a module configured so that when the condition is met, the target ignition timing is set by using the change degree that tends to decrease as the detected engine rotation speed increases. When the engine rotation speed is relatively high, the target ignition timing can be restrained from advancing rapidly, that is, the target ignition timing can be restrained from advancing to the timing at the usual time in too short a period of time.

In another preferable embodiment of the internal combustion engine system of the present invention, the target ignition timing setting module may be a module configured so that when the condition is met, timing advanced in succession for each ignition in each cylinder of the plurality of cylinders with the change degree is set as the target ignition timing.

In still another preferable embodiment of the internal combustion engine system of the present invention, the target ignition timing setting module may be a module configured so that when the condition is met, second delay timing on the delay side by a second delay amount having a delay amount larger than that of a first delay amount as compared with the timing at usual time is set as temporary ignition timing and after the setting, timing advanced in succession from the second delay timing toward the timing at usual time with a change degree based on the detected engine rotation speed is set as temporary ignition timing, and timing on the advance side of the set temporary ignition timing and the first delay timing is set as the target ignition timing. Since the target ignition timing is not on the delay side of a first delay timing, the target ignition timing can be restrained from delaying too much from the timing at the usual time.

In still another preferable embodiment of the internal combustion engine system of the present invention, the target ignition timing setting module may be a module configured so that when the condition is met, until an advance start condition that the target ignition timing begins to be advanced toward the timing at usual time is met, first delay timing on the delay side of the timing at usual time by a first delay amount is set as the target ignition timing, and after the advance start condition has been met, timing advanced in succession from the first delay timing toward the timing at usual time with a change degree based on the detected engine rotation speed is set as the target ignition timing. Since the target ignition timing is not on the delay side of a first delay timing, the target ignition timing can be restrained from delaying too much from the timing at the usual time. In this case, the target ignition timing setting module may be a module configured so that when the condition is met, second delay timing on the delay side by a second delay amount having a delay amount larger than that of a first delay amount as compared with the timing at usual time is set as temporary ignition timing and after the setting, timing advanced in succession from the second delay timing toward the timing at usual time with a change degree based on the detected engine rotation speed is set as temporary ignition timing, and the target ignition timing is set by using a condition that the set temporary ignition timing is on the advance side of the first delay timing as the advance start condition.

In still another preferable embodiment of the internal combustion engine system of the present invention, the internal combustion engine system may further include an intake air quantity detecting unit for detecting an intake air quantity in an intake system of the internal combustion engine, and the target ignition timing setting module is a module configured so that it is judged whether or not the operating state condition is met based on a change rate of the detected intake air quantity, and the target ignition timing is set based on a result of the judgment. In this case, the target ignition timing setting module may be a module configured so that it is judged whether or not the operating state condition is met based on a change rate of the detected intake air quantity and at least either one of the detected intake air quantity and a temperature of the internal combustion engine. Also, the target ignition timing setting module can be made a module configured so that it is judged whether or not the operating state condition is met based on the change rate of the detected intake air quantity and at least either one of the detected intake air quantity and the temperature of the internal combustion engine. In this case, the target ignition timing setting module can be made a module configured so that it is judged whether or not the operating state condition is met based on whether or not the detected intake air quantity is not smaller than a predetermined air quantity, or can be made a module configured so that it is judged whether or not the operating state condition is met based on whether or not the temperature of the internal combustion engine is not lower than a predetermined temperature. In these cases, it can be judged more appropriately whether or not the operating state condition is met.

The present invention is also directed to a vehicle including: an internal combustion engine; an igniting unit capable of accomplishing ignition for each cylinder of the internal combustion engine; a rotation regulating unit that is connected to an output shaft of the internal combustion engine and a drive shaft rotatable independently of the output shaft and connected to an axle, and is capable of regulating a rotation speed of the output shaft with respect to the drive shaft along with input/output of electric power and input/output of driving force to the output shaft and the drive shaft; a motor capable of inputting and outputting power to and from the drive shaft; an engine rotation speed detecting module for detecting an engine rotation speed, which is a rotation speed of the internal combustion engine; a target ignition timing setting module configured so that when an operating state condition that the operating state of the internal combustion engine is a predetermined operating state is met, timing on the delay side is set as target ignition timing as compared with timing at usual time when the operating state condition is not met, and after the setting, timing advanced in succession toward the timing at usual time with a change degree based on the detected engine rotation speed is set as the target ignition timing; and an ignition control module for controlling the igniting unit so that ignition is accomplished at the set target ignition timing.

In the vehicle in accordance with the present invention, the igniting unit is controlled so that when the operating state condition that the operating state of the internal combustion engine is the predetermined operating state is met, the timing on the delay side is set as the target ignition timing as compared with the timing at the usual time when the operating state condition is not met and ignition is accomplished at the set target ignition timing, and subsequently the igniting unit is controlled so that the timing advanced in succession toward the timing at the usual time with the change degree based on the engine rotation speed, which is the rotation speed of the internal combustion engine, is set as the target ignition timing and ignition is accomplished at the set target ignition timing. Therefore, when the condition is met, after ignition has been accomplished at the timing on the delay side of the timing at the usual time, ignition is accomplished at the timing advanced in succession toward the timing at the usual time with the change degree based on the engine rotation speed. Therefore, if a more appropriate change degree is set based on the engine rotation speed, the target ignition timing can be restrained from advancing rapidly, that is, the target ignition timing can be restrained from advancing to the timing at the usual time in too short a period of time, whereby the occurrence of knocking can be restrained. The term “the predetermined operating state” includes an operating state in which knocking may occur due to a sudden change in the operating state of internal combustion engine.

In one preferable embodiment of the vehicle of the present invention, the rotation regulating unit may be a unit having a three shaft-type power input output module that is connected to three shafts, that is, the output shaft of the internal combustion engine, the drive shaft, and a third shaft to input and output power to and from a remaining shaft based on power inputted and outputted to and from any two shafts of the three shafts, and a generator capable of inputting and outputting power to and from the third shaft.

The present invention is also directed to an ignition control method for an internal combustion engine system including an igniting unit capable of accomplishing ignition for each cylinder of an internal combustion engine having a plurality of cylinders. When an operating state condition that the operating state of the internal combustion engine is a predetermined operating state is met, the igniting unit is controlled so that timing on the delay side is set as target ignition timing as compared with timing at usual time when the operating state condition is not met and ignition is accomplished at the set target ignition timing, and after the control, the igniting unit is controlled so that timing advanced in succession toward the timing at usual time with a change degree based on the detected engine rotation speed, which is a rotation speed of the internal combustion engine, is set as the target ignition timing and ignition is accomplished at the set target ignition timing.

In the ignition control method for an internal combustion engine system in accordance with the present invention, the igniting unit is controlled so that when the operating state condition that the operating state of the internal combustion engine is the predetermined operating state is met, the timing on the delay side is set as the target ignition timing as compared with the timing at the usual time when the operating state condition is not met and ignition is accomplished at the set target ignition timing, and subsequently the igniting unit is controlled so that the timing advanced in succession toward the timing at the usual time with the change degree based on the engine rotation speed, which is the rotation speed of the internal combustion engine, is set as the target ignition timing and ignition is accomplished at the set target ignition timing. Therefore, when the condition is met, after ignition has been accomplished at the timing on the delay side of the timing at the usual time, ignition is accomplished at the timing advanced in succession toward the timing at the usual time with the change degree based on the engine rotation speed. Therefore, if a more appropriate change degree is set based on the engine rotation speed, the target ignition timing can be restrained from advancing rapidly, that is, the target ignition timing can be restrained from advancing to the timing at the usual time in too short a period of time, whereby the occurrence of knocking can be restrained. The term “the predetermined operating state” includes an operating state in which knocking may occur due to a sudden change in the operating state of internal combustion engine.

In one preferable embodiment of the ignition control method for an internal combustion engine system of the present invention, the target ignition timing setting module may be a module configured so that when the condition is met, the target ignition timing is set by using the change degree that tends to decrease as the detected engine rotation speed increases. When the engine rotation speed is relatively high, the target ignition timing can be restrained from advancing rapidly, that is, the target ignition timing can be restrained from advancing to the timing at the usual time in too short a period of time.

### BRIEF DESCRIPTION OF THE DRAWINGS

FIG. 1 is a configuration diagram showing the outline of configuration of a hybrid vehicle 20 mounted with a power output apparatus provided with an internal combustion engine system as one embodiment of the present invention;

FIG. 2 is a configuration view showing the outline of configuration of an engine 22;

FIG. 3 is a flowchart showing one example of a drive control routine executed by a hybrid electronic control unit 70 in accordance with an embodiment;

FIG. 4 is an explanatory chart showing one example of a torque demand setting map;

FIG. 5 is an explanatory chart showing one example of an operation line of the engine 22 and a state in which a target rotation speed Ne* and a target torque Te* are set;

FIG. 6 is an explanatory chart showing one example of an alignment chart for dynamically explaining a rotation element of a power distribution and integration mechanism 30;

FIG. 7 is a flowchart showing one example of an ignition control routine executed by an engine ECU 24;

FIG. 8 is an explanatory chart showing one example of an advance amount setting map;

FIG. 9 is an explanatory chart showing one example of a state of time change of target ignition timing Tf*;

FIG. 10 is a configuration view showing the outline of configuration of a hybrid vehicle 120 of a modified example; and

FIG. 11 is a configuration view showing the outline of configuration of a hybrid vehicle 220 of another modified example.

### DESCRIPTION OF THE PREFERRED EMBODIMENTS

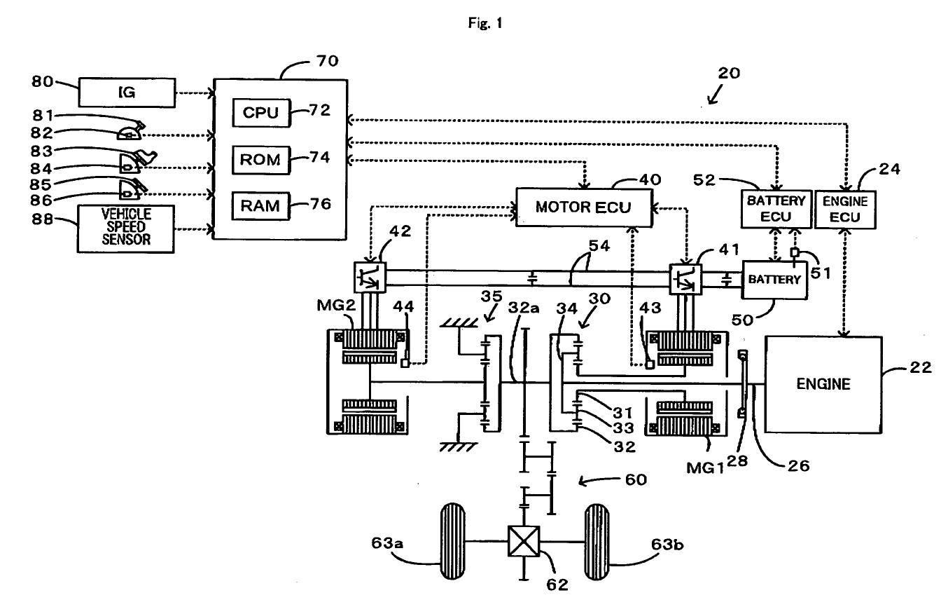

One mode of carrying out the invention is discussed below as a preferred embodiment. FIG. 1 schematically illustrates the construction of a hybrid vehicle 20 with a power output apparatus equipped with an internal combustion engine mounted thereon in one embodiment of the invention. As illustrated, the hybrid vehicle 20 of the embodiment includes an engine 22, a three shaft-type power distribution and integration mechanism 30 that is linked with a crankshaft 26 functioning as an output shaft of the engine 22 via a damper 28, a motor MG1 that is linked with the power distribution and integration mechanism 30 and is capable of generating electric power, a reduction gear 35 that is attached to a ring gear shaft 32a functioning as a drive shaft connected with the power distribution and integration mechanism 30, another motor MG2 that is linked with the reduction gear 35, and a hybrid electronic control unit 70 that controls the whole power output apparatus.

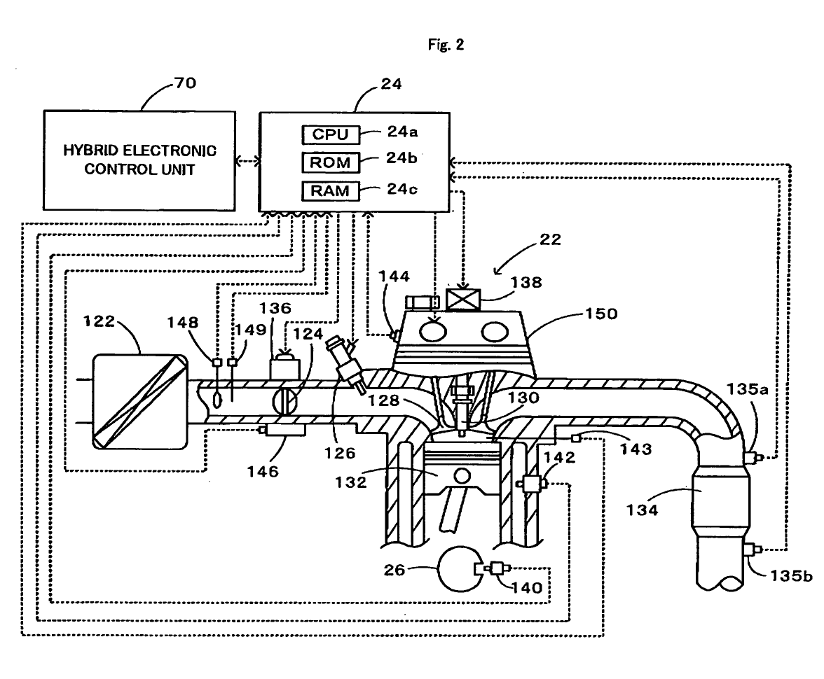

The engine 22 is configured as an internal combustion engine having a plurality of cylinders (for example, six cylinders), which can output power by using a hydrocarbon-based fuel such as gasoline or light oil. In the engine 22, as shown in FIG. 2, the air purified by an air cleaner 122 is sucked via a throttle valve 124, and gasoline is injected from a fuel injection valve 126 and is mixed with the sucked air. This fuel-air mixture is sucked into a fuel chamber via an intake valve 128 and is explosively burned by electric sparks produced by an ignition plug 130, by which the reciprocating motion of a piston 132 pushed down by this explosive energy is converted into the rotational motion of a crankshaft 26. The exhaust gas from the engine 22 is discharged to the outside via a purifier (three way catalyst) 134 for purifying harmful components of carbon monoxide (CO), hydrocarbon (HC), and nitrogen oxides (NOx).

The engine 22 is controlled by an engine electronic control unit (hereinafter referred to as an engine ECU) 24. The engine ECU 24 is configured as a microprocessor mainly including a CPU 24a, and has, in addition to the CPU 24a, a ROM 24b for storing processing programs, a RAM 24c for storing data temporarily, and input and output ports and a communication port, not shown. To the engine ECU 24, signals from various sensors for detecting the state of the engine 22, for example, crank position from a crank position sensor 140 for detecting the rotation position of the crankshaft 26, cooling water temperature from a water temperature sensor 142 for detecting the temperature of cooling water for the engine 22, in-cylinder pressure Pin from a pressure sensor 143 provided in a combustion chamber, cam position from a cam position sensor 144 for detecting the rotation position of a camshaft that opens and closes the intake valve 128 and an exhaust valve for performing air supply and exhaust to and from the combustion chamber, throttle position from a throttle valve position sensor 146 for detecting the position of the throttle valve 124, intake air quantity Qa from an air flowmeter 148 that is attached to an intake pipe to detect the mass flow rate of intake air, intake air temperature from a temperature sensor 149 attached to the intake pipe in the same way, air-fuel ratio AF from an air-fuel ratio sensor 135a, and an oxygen signal from an oxygen sensor 135b are sent via the input port. Also, from the engine ECU 24, various control signals for driving the engine 22, for example, a drive signal to the fuel injection valve 126, a drive signal to a throttle motor 136 for regulating the position of the throttle valve 124, a control signal to an ignition coil 138 integrated with an igniter, and a control signal to a variable valve timing mechanism 150 capable of changing the opening and closing timing of the intake valve 128 are sent out via the output port. The engine ECU 24 communicates with the hybrid electronic control unit 70, and controls the operation of the engine 22 by means of the control signal from the hybrid electronic control unit 70 and also sends data about the operating state of the engine 22 as necessary.

The power distribution and integration mechanism 30 has a sun gear 31 that is an external gear, a ring gear 32 that is an internal gear and is arranged concentrically with the sun gear 31, multiple pinion gears 33 that engage with the sun gear 31 and with the ring gear 32, and a carrier 34 that holds the multiple pinion gears 33 in such a manner as to allow free revolution thereof and free rotation thereof on the respective axes. Namely the power distribution and integration mechanism 30 is constructed as a planetary gear mechanism that allows for differential motions of the sun gear 31, the ring gear 32, and the carrier 34 as rotational elements. The carrier 34, the sun gear 31, and the ring gear 32 in the power distribution and integration mechanism 30 are respectively coupled with the crankshaft 26 of the engine 22, the motor MG1, and the reduction gear 35 via ring gear shaft 32a. While the motor MG1 functions as a generator, the power output from the engine 22 and input through the carrier 34 is distributed into the sun gear 31 and the ring gear 32 according to the gear ratio. While the motor MG1 functions as a motor, on the other hand, the power output from the engine 22 and input through the carrier 34 is combined with the power output from the motor MG1 and input through the sun gear 31 and the composite power is output to the ring gear 32. The power output to the ring gear 32 is thus finally transmitted to the driving wheels 63a and 63b via the gear mechanism 60, and the differential gear 62 from ring gear shaft 32a.

Both the motors MG1 and MG2 are known synchronous motor generators that are driven as a generator and as a motor. The motors MG1 and MG2 transmit electric power to and from a battery 50 via inverters 41 and 42. Power lines 54 that connect the inverters 41 and 42 with the battery 50 are constructed as a positive electrode bus line and a negative electrode bus line shared by the inverters 41 and 42. This arrangement enables the electric power generated by one of the motors MG1 and MG2 to be consumed by the other motor. The battery 50 is charged with a surplus of the electric power generated by the motor MG1 or MG2 and is discharged to supplement an insufficiency of the electric power. When the power balance is attained between the motors MG1 and MG2, the battery 50 is neither charged nor discharged. Operations of both the motors MG1 and MG2 are controlled by a motor electronic control unit (hereafter referred to as motor ECU) 40. The motor ECU 40 receives diverse signals required for controlling the operations of the motors MG1 and MG2, for example, signals from rotational position detection sensors 43 and 44 that detect the rotational positions of rotors in the motors MG1 and MG2 and phase currents applied to the motors MG1 and MG2 and measured by current sensors (not shown). The motor ECU 40 outputs switching control signals to the inverters 41 and 42. The motor ECU 40 communicates with the hybrid electronic control unit 70 to control operations of the motors MG1 and MG2 in response to control signals transmitted from the hybrid electronic control unit 70 while outputting data relating to the operating conditions of the motors MG1 and MG2 to the hybrid electronic control unit 70 according to the requirements.

The battery 50 is under control of a battery electronic control unit (hereafter referred to as battery ECU) 52. The battery ECU 52 receives diverse signals required for control of the battery 50, for example, an inter-terminal voltage measured by a voltage sensor (not shown) disposed between terminals of the battery 50, a charge-discharge current measured by a current sensor (not shown) attached to the power line 54 connected with the output terminal of the battery 50, and a battery temperature Tb measured by a temperature sensor 51 attached to the battery 50. The battery ECU 52 outputs data relating to the state of the battery 50 to the hybrid electronic control unit 70 via communication according to the requirements. The battery ECU 52 calculates a state of charge (SOC) of the battery 50, based on the accumulated charge-discharge current measured by the current sensor, for control of the battery 50.

The hybrid electronic control unit 70 is constructed as a microprocessor including a CPU 72, a ROM 74 that stores processing programs, a RAM 76 that temporarily stores data, and a non-illustrated input-output port, and a non-illustrated communication port. The hybrid electronic control unit 70 receives various inputs via the input port: an ignition signal from an ignition switch 80, a gearshift position SP from a gearshift position sensor 82 that detects the current position of a gearshift lever 81, an accelerator opening Acc from an accelerator pedal position sensor 84 that measures a step-on amount of an accelerator pedal 83, a brake pedal position BP from a brake pedal position sensor 86 that measures a step-on amount of a brake pedal 85, and a vehicle speed V from a vehicle speed sensor 88. The hybrid electronic control unit 70 communicates with the engine ECU 24, the motor ECU 40, and the battery ECU 52 via the communication port to transmit diverse control signals and data to and from the engine ECU 24, the motor ECU 40, and the battery ECU 52, as mentioned previously.

The hybrid vehicle 20 of the embodiment thus constructed calculates a torque demand to be output to the ring gear shaft 32a functioning as the drive shaft, based on observed values of a vehicle speed V and an accelerator opening Acc, which corresponds to a driver's step-on amount of an accelerator pedal 83. The engine 22 and the motors MG1 and MG2 are subjected to operation control to output a required level of power corresponding to the calculated torque demand to the ring gear shaft 32a. The operation control of the engine 22 and the motors MG1 and MG2 selectively effectuates one of a torque conversion drive mode, a charge-discharge drive mode, and a motor drive mode. The torque conversion drive mode controls the operations of the engine 22 to output a quantity of power equivalent to the required level of power, while driving and controlling the motors MG1 and MG2 to cause all the power output from the engine 22 to be subjected to torque conversion by means of the power distribution and integration mechanism 30 and the motors MG1 and MG2 and output to the ring gear shaft 32a. The charge-discharge drive mode controls the operations of the engine 22 to output a quantity of power equivalent to the sum of the required level of power and a quantity of electric power consumed by charging the battery 50 or supplied by discharging the battery 50, while driving and controlling the motors MG1 and MG2 to cause all or part of the power output from the engine 22 equivalent to the required level of power to be subjected to torque conversion by means of the power distribution and integration mechanism 30 and the motors MG1 and MG2 and output to the ring gear shaft 32a, simultaneously with charge or discharge of the battery 50. The motor drive mode stops the operations of the engine 22 and drives and controls the motor MG2 to output a quantity of power equivalent to the required level of power to the ring gear shaft 32a.

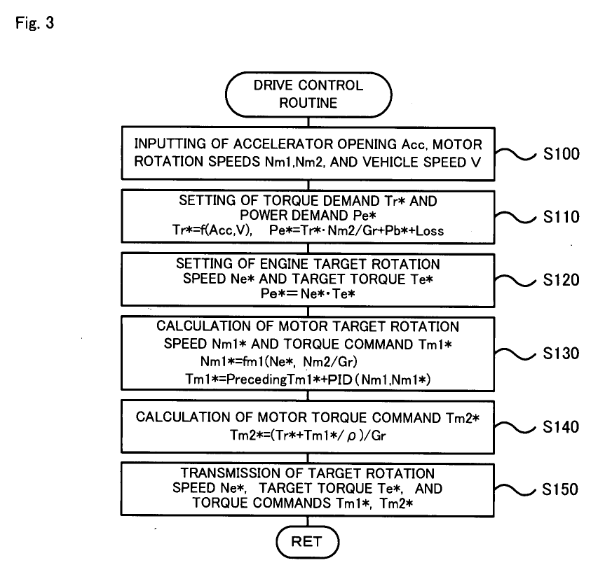

Next, the operation of the hybrid vehicle 20 in accordance with this embodiment, which is configured as described above, is explained. FIG. 3 is a flowchart showing one example of a drive control routine executed by the hybrid electronic control unit 70. This routine is executed repeatedly at predetermined time intervals (for example, at several milliseconds intervals).

When the drive control routine is executed, the CPU 72 of the hybrid electronic control unit 70 first executes processing for inputting data necessary for control, such as accelerator opening Acc from the accelerator pedal position sensor 84, vehicle speed V from the vehicle speed sensor 88, rotation speed Ne of the engine 22, and rotation speeds Nm1 and Nm2 of the motors MG1 and MG2 (Step S100). In this step, for the rotation speed Ne of the engine 22, a rotation speed calculated based on the signal sent from the crank position sensor 140 attached to the crankshaft 26 is inputted by the communication from the engine ECU 24. Also, for the rotation speeds Nm1 and Nm2 of the motors MG1 and MG2, rotation speeds calculated based on the rotation positions of rotors of the motors MG1 and MG2, which are detected by the rotational position detection sensors 43 and 44, are inputted by the communication from the motor ECU 40.

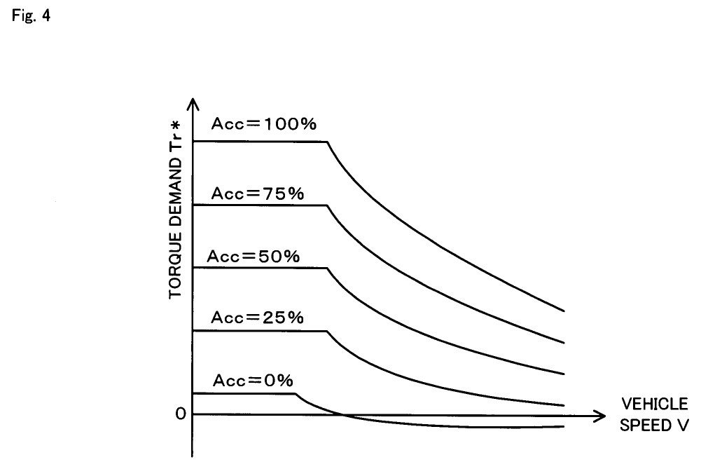

After the data have been inputted in this manner, a torque demand Tr* to be outputted to the ring gear shaft 32a serving as the drive shaft connected to the drive wheels 63a and 63b as a torque required for the vehicle based on the inputted accelerator opening Acc and vehicle speed V and a power demand Pe* required for the engine 22 are set (Step S110). In this embodiment, the torque demand Tr* is set by storing the relationship between the accelerator opening Acc and vehicle speed V and the torque demand Tr*, which has been determined in advance, in the ROM 74 as a torque demand setting map and by deriving the corresponding torque demand Tr* from the stored map when the accelerator opening Acc and vehicle speed V are given. FIG. 4 shows one example of the torque demand setting map. The power demand Pe* can be calculated as the sum of a value obtained by multiplying the set torque demand Tr* by the rotation speed Nr of the ring gear shaft 32a and a charge/discharge power demand Pb* required by the battery 50 and a loss Loss. The rotation speed Nr of the ring gear shaft 32a can be determined by multiplying the vehicle speed V by a conversion factor k, or by dividing the rotation speed Nm2 of the motor MG2 by the gear ratio Gr of the reduction gear 35.

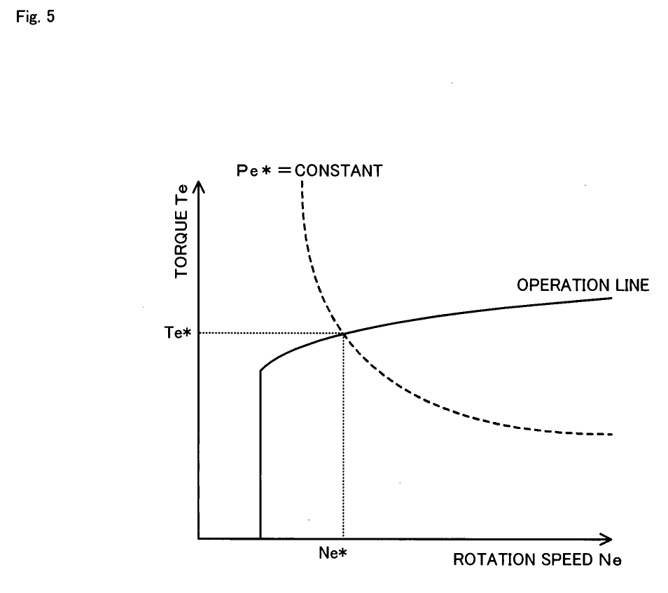

Successively, the target rotation speed Ne* and the target torque Te* of the engine 22 are set based on the set power demand Pe* (Step S120). This setting operation is performed based on an operation line that operates the engine 22 efficiently and the power demand Pe*. FIG. 5 shows one example of the operation line of the engine 22 and the state in which the target rotation speed Ne* and the target torque Te* are set. As shown in FIG. 5, the target rotation speed Ne* and the target torque Te* can be determined by the intersection of the operation line and a curve on which the power demand Pe* (Ne*×Te*) is constant.

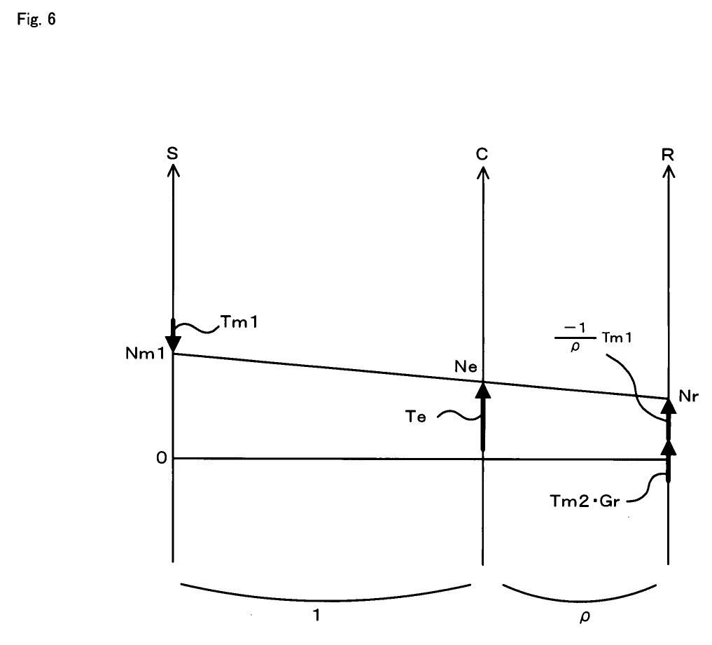

Next, the target rotation speed Nm1* of the motor MG1 is calculated by Equation (1) using the set target rotation speed Ne*, the rotation speed Nr (Nm2/Gr) of the ring gear shaft 32a, and the gear ratio ρ of the power distribution and integration mechanism 30, and also the torque command Tm1* of the motor MG1 is calculated by Equation (2) based on the calculated target rotation speed Nm1* and the present rotation speed Nm1 (Step S130). Then, the torque command Tm2* of the motor MG2 is calculated by Equation (3) using the torque demand Tr*, the torque command Tm1*, the gear ratio ρ of the power distribution and integration mechanism 30, and the gear ratio Gr of the reduction gear 35 (Step S140). Herein, Equation (1) is a dynamic relational expression for the rotation element of the power distribution and integration mechanism 30. FIG. 6 shows an alignment chart showing a dynamic relationship between rotation speed and torque in the rotation element of the power distribution and integration mechanism 30. In FIG. 6, the left S axis represents the rotation speed of the sun gear 31, which is the rotation speed Nm1 of the motor MG1, the C axis represents the rotation speed of the carrier 34, which is the rotation speed Ne of the engine 22, and the R axis represents the rotation speed Nr of the ring gear 32, which is obtained by dividing the rotation speed Nm2 of the motor MG2 by the gear ratio Gr of the reduction gear 35. Two thick arrow marks on the R axis indicate a torque applied to the ring gear shaft 32a by the torque Tm1 generated from the motor MG1 and a torque applied to the ring gear shaft 32a via the reduction gear 35 by the torque Tm2 generated from the motor MG2. Equation (1) and Equation (3) can be derived easily by using this alignment chart. Also, Equation (2) is a relational expression in the feedback control for rotating the motor MG1 at the target rotation speed Nm1*. In Equation (2), “k1” in the second term on the right-hand side is the gain of proportional term, and “k2” in the third term on the right-hand side is the gain of integral term.

Nm1*Ne*·(1+ρ)/ρ−Nm2/(Grp) (1)

Tm1*=preceding Tm1*+k1(Nm1*−Nm1)+K2∫(Nm1*−Nm1)dt (2)

Tm2*=(Tr*+Tm1*/ρ)/Gr (3)

After the target rotation speed Ne* and target torque Te* of the engine 22 and the torque commands Tm1* and Tm2* of the motors MG1 and MG2 have been set, the target rotation speed Ne* and target torque Te* of the engine 22 are sent to the engine ECU 24, and the torque commands Tm1* and Tm2* of the motors MG1 and MG2 are sent to the motor ECU 40 (Step S150), and the drive control routine is finished. The motor ECU 40 that has received the torque commands Tm1* and Tm2* carries out switching control of switching elements of the inverters 41 and 42 so that the motor MG1 is driven by the torque command Tm1* and the motor MG2 is driven by the torque command Tm2*.

Next, the operation of the engine 22 is explained. The engine ECU 24 that has received the target rotation speed Ne* and the target torque Te* sent from the hybrid electronic control unit 70 carries out intake air quantity control, fuel injection control, ignition control, opening/closing timing control of the intake valve 128, and other controls in the engine 22 so that the engine 22 is operated efficiently at an operation point represented by the target rotation speed Ne* and the target torque Te*. In this embodiment, the intake air quantity control, fuel injection control, ignition control, opening/closing timing control of the intake valve 128 are carried out as described below. The relationship between the operation point (rotation speed Ne, torque Te) of the engine 22 and the throttle opening, fuel injection quantity, ignition timing, and opening/closing timing of the intake valve 128 for the engine 22 to be operated efficiently is determined in advance by an experiment or the like and is stored in the ROM 24b of the engine ECU 24 as a control value setting map, and when the target rotation speed Ne* and the target torque Te* are given, corresponding control values (throttle opening, fuel injection quantity, ignition timing (timing T1, described later), opening/closing timing of the intake valve 128) are derived from the stored map, by which the throttle valve 124 is driven, fuel is injected from the fuel injection valve 126, a voltage is applied to the ignition plug 130, or the variable valve timing mechanism 150 is driven by using the control value. Since the intake air quantity control, the fuel injection control, and the opening/closing timing control of the intake valve 128 are not the nuclei of the present invention, more detailed explanation of these controls is omitted.

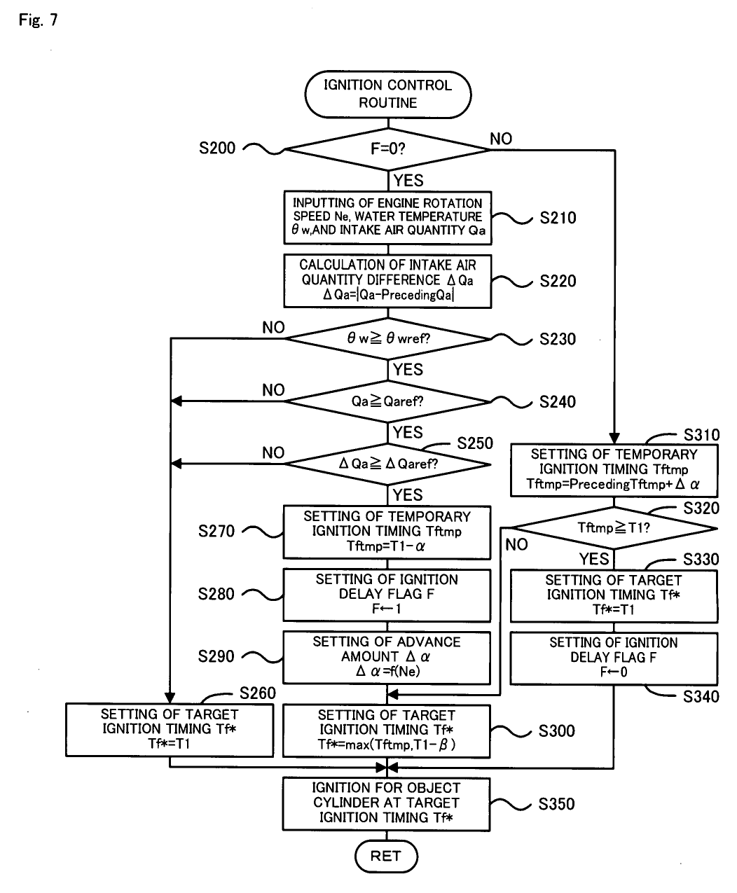

FIG. 7 is a flowchart showing one example of an ignition control routine executed by the engine ECU 24 of this embodiment. This routine is executed repeatedly. When the ignition control routine is executed, the CPU 24a of the engine ECU 24 first examines an ignition delay flag F, described later (Step S200). The ignition delay flag F is a flag on which 0 is set as the initial value and 1 is set when the ignition timing delays from the timing at the time when the engine 22 is operated efficiently (timing T1, described later).

When 0 is set on the ignition delay flag F, the data necessary for control, such as the rotation speed Ne of the engine 22, the cooling water temperature θw from the water temperature sensor 142, and the intake air quantity Qa from the air flowmeter 148 are inputted (Step S210), and an intake air quantity difference ΔQa is calculated as a difference between the intake air quantity Qa inputted this time and the intake air quantity inputted when this routine was executed at the last time (preceding Qa) (Step S220). The rotation speed Ne of the engine 22 is inputted by reading the rotation speed that has been calculated by an engine rotation speed calculation routine, not shown, based on the signal from the crank position sensor 140 attached to the crankshaft 26 and has been written at a predetermined address in the RAM 24c.

Then, the cooling water temperature θw is compared with a threshold value θwref (Step S230), the intake air quantity Qa is compared with a threshold value Qaref (Step S240), and the intake air quantity difference ΔQa is compared with a threshold value ΔQaref (Step S250). It is assumed that the accelerator pedal 83 is depressed hard by the driver. At this time, in the drive control routine shown in FIG. 3, the torque demand Tr* increases suddenly, and accordingly the power demand Pe* changes suddenly, so that the target rotation speed Ne* and the target torque Te* at the operation point of the engine 22 change suddenly. Therefore, if the intake air quantity control, fuel injection control, ignition control, and opening/closing timing control of the intake valve 128 are carried out accordingly by the engine ECU 24, the operating state of the engine 22 changes suddenly and therefore a lean state is easily established, which may cause knocking. Moreover, it is thought that such knocking occurs easily especially when the cooling water temperature Tw is high to some degree or when the intake air quantity Qa is relatively large. On the other hand, if the accelerator pedal 83 is subsequently kept in a hard depressed state, the target rotation speed Ne* and target torque Te* of the engine 22 become substantially constant. Therefore, the engine 22 is operated substantially in a steady state, and the possibility for knocking to occur becomes low. The processing in Steps S230 to S250 is carried out to judge whether or not the condition that the operating state of the engine 22 is an operating state in which knocking may occur due to the sudden change thereof (hereinafter, this condition is referred to as a transient knocking occurrence prediction condition) is met. The threshold value θwref, threshold value Qaref, and threshold value ΔQaref are threshold values used to judge whether or not the transient knocking occurrence prediction condition is met, and are determined by the characteristics etc. of the engine 22. For example, to the threshold value θwref, 70° C., 80° C., 90° C., or other temperatures can be set, to the threshold value Qaref, an air quantity corresponding to 60%, 70%, 80%, or other percentages of the maximum intake air quantity Qamax capable of being sucked into the engine 22 can be set, and to the threshold value ΔQaref, a change amount corresponding to 3%, 5%, 10%, or other percentages of the intake air quantity inputted when the preceding routine was executed, or a change amount corresponding to 2%, 3%, 5%, or other percentages of the maximum intake air quantity Qamax can be set.

When the cooling water temperature θw is lower than the threshold value θwref, when the intake air quantity Qa is smaller than the threshold value Qaref, or when the intake air quantity difference ΔQa is smaller than the threshold value ΔQaref, it is judged that the transient knocking occurrence prediction condition is not met, and the timing T1 at the time when the engine 22 is operated efficiently is set as target ignition timing Tf* (Step S260), and a control signal is sent to the ignition coil 138 so that ignition for the object cylinder is accomplished at the set target ignition timing Tf* (Step S350), by which the ignition control routine is finished. This routine is executed repeatedly. Therefore, in the case where the engine 22 has a plurality of cylinders, when this routine is executed next time, ignition is accomplished at the target ignition timing Tf* for a cylinder different from the cylinder for which ignition has just been accomplished (next cylinder). Thus, ignition is accomplished for the cylinders in succession. In this embodiment, as described above, the timing T1 is set according to the target rotation speed Ne* or the target torque Te* of the engine 22.

In Steps S230 to S250, when the cooling water temperature θw is not lower than the threshold value θwref, the intake air quantity Qa is not smaller than the threshold value Qaref, and the intake air quantity difference ΔQa is not smaller than the threshold value ΔQaref, it is judged that the transient knocking occurrence prediction condition is met, and timing (T1−α) delayed by a delay amount α from the aforementioned timing T1 is set as temporary ignition timing Tftmp (Step S270), and 1 is set on the ignition delay flag F (Step S280). The delay amount α is a delay amount that delays the ignition timing to restrain the occurrence of knocking when knocking may occur. The delay amount α can be set based on the characteristics etc. of the engine 22, and 16 degrees, 18 degrees, 20 degrees, or other degrees can be set to the delay amount α. In this embodiment, for explanation convenience, regarding the timing, the advance side is called positive, and the delay side is called negative.

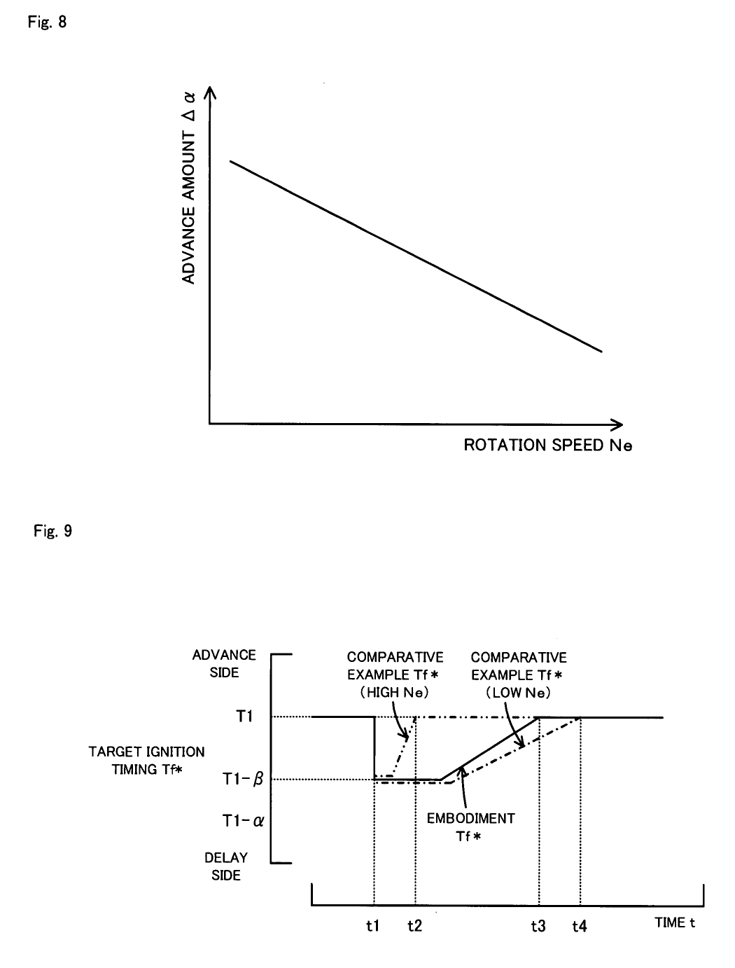

Next, an advance amount Δα is set based on the rotation speed Ne of the engine 22 (Step S290). The advance amount Δα is an advance amount for each ignition at the time when the target ignition timing Tf* is advanced to the timing T1 when this routine is executed after the timing (T1−α) has been set as the temporary ignition timing Tftmp, that is, when this routine is executed next time and thereafter. In this embodiment, the advance amount Δα is set by determining the relationship between the rotation speed Ne of the engine 22 and the advance amount Δα in advance by an experiment or the like and storing it in the ROM 24b as an advance amount setting map, and by deriving the advance amount Δα from the stored map when the rotation speed Ne of the engine 22 is given. FIG. 8 shows one example of the advance amount setting map. As shown in FIG. 8, the advance amount Δα is set so as to tend to decrease linearly as the rotation speed Ne of the engine 22 increases. For example, the advance amount Δα is set at about 1.5 degrees when the rotation speed Ne of the engine 22 is relatively low, and is set at about 0.5 degree when the rotation speed Ne of the engine 22 is relatively high. The reason for setting the advance amount Δα in this manner is described later.

Then, the ignition timing on the advance side of the set temporary ignition timing Tftmp and timing (T1−β) delayed by a delay amount β from the timing T1 is set as the target ignition timing Tf* (Step S300), and ignition for the object cylinder is accomplished at the set target ignition timing Tf* (Step S350), by which the ignition control routine is finished. The restriction delay amount β is a delay amount for restraining excessive delay. A delay amount smaller than the delay amount α can be set, and for example, 10 degrees, 12 degrees, 14 degrees, and other degrees can be set. Thereby, the ignition timing can be restrained from becoming excessively on the delay side. As described above, usually, when the ignition timing is on the delay side, the torque delivered from the engine 22 decreases. In this embodiment, the target ignition timing Tf* is set as the timing on the advance side of the temporary ignition timing Tftmp and the timing (T1−β), by which the torque delivered from the engine 22 is restrained from becoming too low.

If 1 is set on the ignition delay flag F in Step S200, the timing (preceding Tftmp+Δα) advanced by the advance amount Δα from the temporary ignition timing (preceding Tftmp) set when this routine was executed at the last time is set as the temporary ignition timing Tftmp (Step S310). This processing is carried out to advance the temporary ignition timing Tftmp toward the timing T1 from the timing (T1−α) for each ignition. It is assumed that the rotation speed Ne of the engine 22 is relatively high. At this time, if a relatively large fixed value (for example, 1.5 degrees) is used as the advance amount Δα regardless of the rotation speed Ne of the engine 22, since the time interval between ignitions is relatively short, the target ignition timing Tf* is advanced rapidly, that is, the target ignition timing Tf* is advanced to the timing T1 in too short a period of time. In this case, knocking may occur due to the rapid advance of the target ignition timing Tf*. On the other hand, if the advance amount Δα that tends to decrease as the rotation speed Ne of the engine 22 increases is used, the target ignition timing Tf* can be restrained from advancing rapidly when the rotation speed Ne of the engine 22 is relatively high, that is, the target ignition timing Tf* can be restrained from advancing to the timing T1 in too short a period of time. Thereby, the occurrence of knocking due to the rapid advance of the target ignition timing Tf* can be restrained. Also, since the target ignition timing Tf* is restrained from advancing to the timing T1 in too short a period of time, when the transient knocking occurrence prediction condition is still met, that is, before the transient knocking occurrence prediction condition is not met, the target ignition timing Tf* can be restrained from becoming the timing T1. It can be thought that a relatively small fixed value (for example, 0.5 degree) is used as the advance amount Δα regardless of the rotation speed Ne* of the engine 22. In this case, however, when the rotation speed Ne of the engine 22 is relatively low, the time required to advance the target ignition timing Tf* to the timing T1 becomes long.

Successively, the set temporary ignition timing Tftmp is compared with the timing T1 (Step S320). If the temporary ignition timing Tftmp is on the delay side of the timing T1, the ignition timing on the advance side of the temporary ignition timing Tftmp and the timing (T1−β) is set as the target ignition timing Tf* (Step S300), and ignition for the object cylinder is accomplished at the set target ignition timing Tf* (Step S350), by which the ignition control routine is finished. In this manner, the ignition control routine is executed repeatedly. If the temporary ignition timing Tftmp is equal to or on the advance side of the timing T1 in Step S320, the timing T1 is set as the target ignition timing Tf* (Step S330), and 0 is set on the ignition delay flag F (Step S340). Then, ignition for the object cylinder is accomplished at the target ignition timing Tf* (Step S350), by which the ignition control routine is finished.

FIG. 9 is an explanatory chart showing one example of a state of time change of ignition timing of the engine 22. In FIG. 9, the solid line indicates the state of time change of the target ignition timing Tf* in the case where the advance amount Δα that tends to decrease as the rotation speed Ne increases is used. The chain line and the two-dot chain line each indicate the state of time change of the target ignition timing Tf* in the case where a fixed value is used as the advance amount Δα when the rotation speed Ne of the engine 22 is relatively low and relatively high for comparison, respectively. In the case where the fixed value is set to the advance amount Δα regardless of the rotation speed Ne of the engine 22, as indicated by the chain line in FIG. 9, when the rotation speed Ne of the engine 22 is relatively low, the time required to advance the target ignition timing Tf* to the timing T1 (time t1 to t4) is long, and as indicated by the two-dot chain line in FIG. 9, when the rotation speed Ne of the engine 22 is relatively high, the target ignition timing Tf* is advanced rapidly, so that the time from when the ignition timing is delayed from the timing T1 to when the ignition timing is advanced to the timing T1 (time t1 to t2) is too short. In contrast, in the case where the advance amount Δα that tends to decrease as the rotation speed Ne of the engine 22 increases is used, if the advance amount Δα is adjusted properly according to the rotation speed Ne of the engine 22, as indicated by the solid line in FIG. 9, the time from when the target ignition timing Tf* is delayed from the timing T1 to when the target ignition timing Tf* returns to the timing T1 (time t1 to t3) can be made substantially constant regardless of the rotation speed Ne of the engine 22. Thereby, a disadvantage suffered from rapid advancing of the target ignition timing Tf* and a disadvantage suffered from a large difference in time from delay start to delay finish produced according to the rotation speed Ne of the engine 22 can be eliminated.

According to the hybrid vehicle 20 of this embodiment explained above, when the transient knocking occurrence prediction condition that the engine 22 is in an operating state in which knocking may occur due to the sudden change of operating state of the engine 22 is met, ignition for the object cylinder is accomplished at the target ignition timing Tf* delayed from the timing T1, and subsequently, ignition for the object cylinder is accomplished at the target ignition timing Tf* advanced by the advance amount Δα, which decreases as the rotation speed Ne of the engine 22 increases, at a time. Therefore, when the rotation speed Ne of the engine 22 is relatively high, rapid advancing of the target ignition timing Tf*, that is, advancing of the target ignition timing Tf* to the timing T1 in too short a period of time can be restrained. As the result, the occurrence of knocking can be restrained. Moreover, when the transient knocking occurrence prediction condition is met, the timing on the advance side of the temporary ignition timing Tftmp and the timing (T1−β) is set as the target ignition timing Tf*, so that excessive delay can be restrained.

For the hybrid vehicle 20 of this embodiment, by using the cooling water temperature θw, the intake air quantity Qa, and the intake air quantity difference ΔQa, it is judged whether or not the transient knocking occurrence prediction condition is met. However, it is not essential to use one or both of the cooling water temperature θw and the intake air quantity Qa. Also, in place of or in addition to the cooling water temperature θw, the intake air quantity Qa, and the intake air quantity difference ΔQa, the rotation speed Ne of the engine 22, the torque Te delivered from the engine 22, a change in the rotation speed Ne or the torque Te, or the like may be used to judge whether or not the transient knocking occurrence prediction condition is met. The torque Te delivered from the engine 22 can be calculated by using, for example, the torque command Tm1* of the motor MG1 and the gear ratio ρ of the power distribution and integration mechanism 30.

For the hybrid vehicle 20 of this embodiment, when the transient knocking occurrence prediction condition is met, the target ignition timing Tf* is allowed to approach the timing T1 by the advance amount Δα at a time after the temporary ignition timing Tftmp has become on the advance side of the timing (T1−β). However, the target ignition timing Tf* may be allowed to approach the timing T1 by using the advance amount Δα based on the rotation speed Ne of the engine 22 after the transient knocking occurrence prediction condition has been met, that is, after predetermined time has elapsed from when the timing (T1−β) began to be set as the target ignition timing Tf*.

For the hybrid vehicle 20 of this embodiment, the target ignition timing Tf* is restricted so as to be not on the delay side of the timing (T1−β). However, it is not essential to restrict the target ignition timing Tf*. In this case, in place of the processing in Step S300 of the ignition control routine shown in FIG. 7, processing for setting the temporary ignition timing Tftmp as the target ignition timing Tf* may be carried out.

For the hybrid vehicle 20 of this embodiment, as shown in FIG. 8, the advance amount Δα is set so as to tend to decrease linearly as the rotation speed Ne of the engine 22 increases. However, the advance amount Δα may be set so as to tend to decrease curvedly or stepwise.

For the hybrid vehicle 20 of this embodiment, after the timing (T1−α) has been set as the temporary target ignition timing Tftmp, the timing advanced by the advance amount Δα at a time for each ignition from the timing (T1−α) toward the timing T1 is set as the temporary target ignition timing Tftmp. However, the setting of the timing is not limited to each ignition. The timing advanced by the advance amount Δα at a time, for example, for each cycle of the engine 22, that is, each time the engine 22 rotates two turns may be set as the temporary target ignition timing Tftmp.

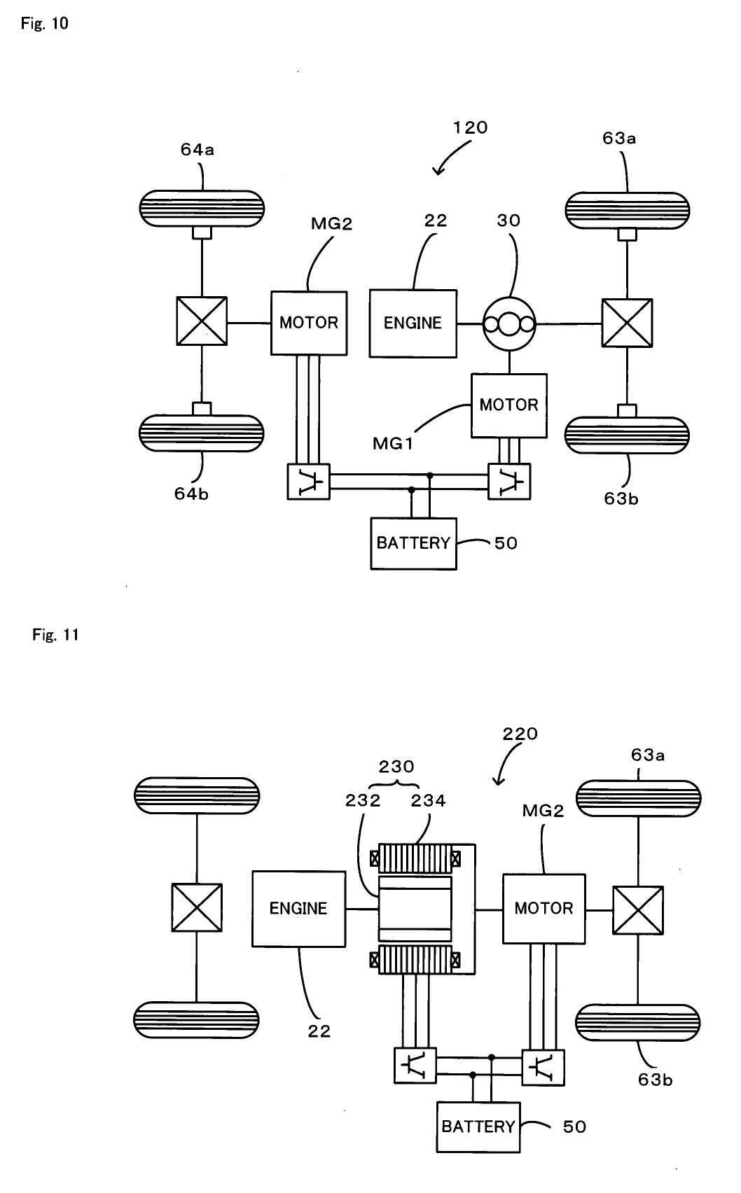

In the hybrid vehicle 20 of the embodiment, the power of the motor MG2 is subjected to gear change by the reduction gear 35 and is output to the ring gear shaft 32a. In one possible modification shown as a hybrid vehicle 120 of FIG. 10, the power of the motor MG2 may be output to another axle (that is, an axle linked with wheels 64a and 64b), which is different from an axle connected with the ring gear shaft 32a (that is, an axle linked with the wheels 63a and 63b).

In the hybrid vehicle 20 of the embodiment, the power of the engine 22 is output via the power distribution and integration mechanism 30 to the ring gear shaft 32a functioning as the drive shaft linked with the drive wheels 63a and 63b. In another possible modification of FIG. 11, a hybrid vehicle 220 may have a pair-rotor motor 230, which has an inner rotor 232 connected with the crankshaft 26 of the engine 22 and an outer rotor 234 connected with the drive shaft for outputting the power to the drive wheels 63a, 63b and transmits part of the power output from the engine 22 to the drive shaft while converting the residual part of the power into electric power.

Next, the corresponding relationship between the essential elements in the embodiment and modifications and the essential elements in the inventions described in the section of summary is explained. In the embodiment, the four-cylinder engine 22 corresponds to “an internal combustion engine”. The ignition plug 130 and the ignition coil 138 correspond to “igniting units”. The crank position sensor 140 that detects the rotational position of the crankshaft 26 and the engine ECU 24 that calculates the rotation speed of the engine 22 based on the crank position from the crank position sensor 140 corresponds to “an engine rotation speed detecting module”. The engine ECU 24 corresponds to “a target ignition timing setting module”, which judges, whether or not the transient knocking occurrence prediction condition that the engine 22 is in a condition in which knocking may occur due to the sudden change of operating state of the engine 22 is met based on the cooling water temperature θw, the intake air quantity Qa, and the intake air quantity difference ΔQa, sets the timing T1 as the target ignition timing Tf* if the transient knocking occurrence prediction condition is not met, sets the timing delayed by the delay amount α from the timing T1 as the temporary ignition timing Tftmp and sets the timing on the advance side of the set temporary ignition timing Tftmp and the timing (T1−β) as the target ignition timing Tf* if the transient knocking occurrence prediction condition is met, and subsequently sets the timing advanced by the advance amount Δα that is set so as to tend to decrease from the preceding temporary ignition timing (preceding Tftmp) as the rotation speed Ne of the engine 22 increases as the temporary ignition timing Tftmp and sets the timing on the advance side of the set temporary ignition timing Tftmp and the timing (T1−β) as the target ignition timing Tf*. The engine ECU 24 that sends a control signal to the ignition coil 138 so that ignition for the object cylinder is accomplished at the set target ignition timing Tf* corresponds to “an ignition control module”. Also, the power distribution and integration mechanism 30 connected to the crankshaft 26 of the engine 22 and the ring gear shaft 32a serving as a drive shaft and the motor MG1 connected to the power distribution and integration mechanism 30 correspond to “rotation regulating unit”, and the motor MG2 connected to the ring gear shaft 32a corresponds to “a motor”. The corresponding relationship between the essential elements in the embodiment and modifications and the essential elements in the inventions described in the section of summary does not restrict the essential elements in the inventions described in the section of summary because the embodiment is one example for concretely explaining the best mode for carrying out the invention described in the section of summary. That is to say, the interpretation of the inventions described in the section of summary should be made based on the description in that section, and the embodiment is only one specific example of the inventions described in the section of summary.

Also, anything provided with an internal combustion engine can be controlled by the same routine as the ignition control routine in the above-described embodiment. Therefore, the present invention may have a mode of a power output apparatus or an internal combustion engine system mounted on an mobile object provided with an internal combustion engine, such as an automobile, vehicle, ship, and airplane, or may have a mode of a power output apparatus or an internal combustion engine system incorporated in immovable equipment such as a construction facility. Also, the present invention may have a mode of an ignition control method for the above-described power output apparatus or internal combustion engine system.

The embodiment discussed above is to be considered in all aspects as illustrative and not restrictive. There may be many modifications, changes, and alterations without departing from the scope or spirit of the main characteristics of the present invention. The scope and spirit of the present invention are indicated by the appended claims, rather than by the foregoing description.

The disclosure of Japanese Patent Application No. 2006-301982 filed Nov. 7, 2006 including specification, drawings and claims is incorporated herein by reference in its entirety.

What is claimed is:

1. An internal combustion engine system provided with an internal combustion engine having a plurality of cylinders, said internal combustion engine system comprising:
an igniting unit capable of accomplishing ignition for each cylinder of said internal combustion engine;
an engine rotation speed detecting module for detecting an engine rotation speed, which is a rotation speed of said internal combustion engine;
a target ignition timing setting module configured so that when an operating state condition that the operating state of said internal combustion engine is a predetermined operating state is met, timing on a delay side is set as a target ignition timing as compared with a timing at usual time when said operating state condition is not met, and after said setting, timing advanced in succession toward said timing at usual time with a change degree based on said detected engine rotation speed is set as said target ignition timing; and
an ignition control module for controlling said igniting unit so that ignition is accomplished at said set target ignition timing.

2. An internal combustion engine system according to claim 1, wherein
said target ignition timing setting module is a module configured so that when said condition is met, said target ignition timing is set by using said change degree that tends to decrease as said detected engine rotation speed increases.

3. An internal combustion engine system according to claim 1, wherein
said target ignition timing setting module is a module configured so that when said condition is met, timing advanced in succession for each ignition in each cylinder of said plurality of cylinders with said change degree is set as said target ignition timing.

4. An internal combustion engine system according to claim 1, wherein
said target ignition timing setting module is a module configured so that when said condition is met, second delay timing on the delay side by a second delay amount having a delay amount larger than that of a first delay amount as compared with said timing at usual time is set as temporary ignition timing and after said setting, timing advanced in succession from said second delay timing toward said timing at usual time with a change degree based on said detected engine rotation speed is set as temporary ignition timing, and timing on the advance side of said set temporary ignition timing and said first delay timing is set as said target ignition timing.

5. An internal combustion engine system according to claim 1, wherein
said target ignition timing setting module is a module configured so that when said condition is met, until an advance start condition that said target ignition timing begins to be advanced toward said timing at usual time is met, first delay timing on the delay side of said timing at usual time by a first delay amount is set as said target ignition timing, and after said advance start condition has been met, timing advanced in succession from said first delay timing toward said timing at usual time with a change degree based on said detected engine rotation speed is set as said target ignition timing.

6. An internal combustion engine system according to claim 5, wherein
said target ignition timing setting module is a module configured so that when said condition is met, second delay timing on the delay side by a second delay amount having a delay amount larger than that of a first delay amount as compared with said timing at usual time is set as temporary ignition timing and after said setting, timing advanced in succession from said second delay timing toward said timing at usual time with a change degree based on said detected engine rotation speed is set as temporary ignition timing, and said target ignition timing is set by using a condition that said set temporary ignition timing is on the advance side of said first delay timing as said advance start condition.

7. An internal combustion engine system according to claim 1, wherein
said internal combustion engine system further comprises an intake air quantity detecting unit for detecting an intake air quantity in an intake system of said internal combustion engine, and
said target ignition timing setting module is a module configured so that it is judged whether or not said operating state condition is met based on a change rate of said detected intake air quantity, and said target ignition timing is set based on a result of said judgment.

8. An internal combustion engine system according to claim 7, wherein
said target ignition timing setting module is a module configured so that it is judged whether or not said operating state condition is met based on a change rate of said detected intake air quantity and at least either one of said detected intake air quantity and a temperature of said internal combustion engine.

9. A vehicle comprising:
an internal combustion engine;
an igniting unit capable of accomplishing ignition for each cylinder of said internal combustion engine;
a rotation regulating unit that is connected to an output shaft of said internal combustion engine and a drive shaft rotatable independently of said output shaft and connected to an axle, and is capable of regulating a rotation speed of said output shaft with respect to said drive shaft along with input/output of electric power and input/output of driving force to said output shaft and said drive shaft;
a motor capable of inputting and outputting power to and from said drive shaft;
an engine rotation speed detecting module for detecting an engine rotation speed, which is a rotation speed of said internal combustion engine;
a target ignition timing setting module configured so that when an operating state condition that the operating state of said internal combustion engine is a predetermined operating state is met, timing on the delay side is set as target ignition timing as compared with timing at usual time when said operating state condition is not met, and after said setting, timing advanced in succession toward said timing at usual time with a change degree based on said detected engine rotation speed is set as said target ignition timing; and
an ignition control module for controlling said igniting unit so that ignition is accomplished at said set target ignition timing.

10. A vehicle according to claim 9, wherein
said rotation regulating unit is a unit having a three shaft-type power input output module that is connected to three shafts, that is, said output shaft of said internal combustion engine, said drive shaft, and a third shaft to input and output power to and from a remaining shaft based on power inputted and outputted to and from any two shafts of said three shafts, and a generator capable of inputting and outputting power to and from said third shaft.

11. An ignition control method for an internal combustion engine system comprising an igniting unit capable of accomplishing ignition for each cylinder of an internal combustion engine having a plurality of cylinders, wherein
when an operating state condition that the operating state of said internal combustion engine is a predetermined operating state is met, said igniting unit is controlled so that timing on the delay side is set as target ignition timing as compared with timing at usual time when said operating state condition is not met and ignition is accomplished at said set target ignition timing, and after said control, said igniting unit is controlled so that timing advanced in succession toward said timing at usual time with a change degree based on said detected engine rotation speed, which is a rotation speed of said internal combustion engine, is set as said target ignition timing and ignition is accomplished at said set target ignition timing.

12. An ignition control method for an internal combustion engine system according to claim 11, wherein when said condition is met, said target ignition timing is set by using said change degree that tends to decrease as said detected engine rotation speed increases.
